(19) United States
(12) Patent Application Publication
(10) Pub. No.: US 2002/0136380 A1
(43) Pub. Date: Sep. 26, 2002

(54) Data backup system for portable telephone and method for backing up data for portable telephone

(76) Inventor: Shinji Aoyama, Ichikawa-shi (JP)

Correspondence Address: Joseph J Corso, Pearne & Gordon, Suite 1200, 526 Superior Avenue East, Cleveland, OH, 44114-1484, US

(21) Appl. No.: 10/088,041

(22) PCT Filed: Jul. 11, 2001
(86) PCT No.: PCT/JP01/06008

(30) Foreign Application Priority Data
Jul. 14, 2000 (JP) 2000-215241

(51) Int. Cl. H04M 3/42; H04M 7/00

(52) U.S. Cl. 379/201.01; 379/219

(57) ABSTRACT

There is provided a data backup unit 14 having a charging connection terminal 24 to be connected to a charging terminal 22 of a portable telephone 12 and an information transmission connection terminal 24a to be connected to an external information instrument connection terminal 22a. The data backup unit 14 automatically reads through the information transmission connection terminal 24a the data including at least the control information stored in the portable telephone 12 and to be backed up in association with the charging operation when the portable telephone is put in the data backup unit 14 for charging it and automatically transmits the data through the communication modem or the like to the database center 16 in association with the reading process.

### TECHNICAL FIELD

This invention relates to a data backup system for backing up data such as telephone numbers set and stored in a portable telephone and a method of backing up these data while using the data backup system.

### BACKGROUND OF THE INVENTION

Since such portable telephones as cellular phones, personal handy phones (referred as to “PHS” later) and so on generally have a memory dial function for which the telephone numbers of partners are previously set and stored in the telephones, many users can manage the telephone numbers of the partners by the memory dial function without memorizing the telephone numbers in another memory.

Thus, if the data such as the telephone numbers of the partners happen to be not able to be utilized because of a loss or a failure of the portable telephones or because of a loss of the data due to external causes such as erroneous operation, shocks and so on, the users would suffer great disadvantages.

In addition to the case where the data cannot be utilized as aforementioned, in the case where the old portable telephone is replaced by a new portable telephone, it will take much time for the user itself to input the same data as those stored in the old telephone into the new telephone. Furthermore, if the data such as the telephone numbers stored in one telephone might be utilized for another telephone, a convenience of the telephones would increase.

In consideration of the aforementioned points, there have been proposed many arts in which the data such as the telephone numbers stored in the portable telephones are stored into external storages such as memory cards. These arts are disclosed in JP55-128955, JP58-58669, JP60-49463, JP61-20464, JP61-43050, JP64-22153, JP2-172355, JP4-302245, JP5-145476, JP9-64959, JP10-32631, JP11-74962 and JU62-112241.

Furthermore, there have been proposed other arts in which the data such as the telephone numbers are delivered and received through an external information device connection terminal of the portable telephone to and from a general information processing equipment called as a mobile gear or a personal computer without using any equipment peculiarly prepared for storing the telephone numbers. These arts are disclosed in JP5-56131, JP5-292172, JP6-46120, JP6-90309, JP6-244986, JP7-111525 and JP8-6902, for example.

However, these prior arts should disadvantageously prepare the equipment, which is peculiarly used for the external storage of the data, but never used in a condition of normally using the portable telephones and also the cable for connection thereof separately from the portable telephones. Some arts require a special interface or construction for connection of the external storage provided on the side of the telephones. This disadvantageously tends to make these arts inapplicable to the existing telephones.

There has been proposed an art in which abbreviating dial information is stored in an external storage prepared in a telephone operation station without preparing it on the side of the user of the portable telephone or an external storage is installed in an exchange station or an exclusive contractor so that other portable telephones can commonly use the abbreviating dial information. This art is disclosed in JP8-307944, JP2000-78070 and JP2000-124985.

However, since any of the aforementioned prior arts including the art in which the external storage is provided in the exchange station or the like requires the operation which the users themselves memorize such data as the telephone numbers and so on in the external storage, back up them or make an instruction therefor, the operation is much troublesome.

As a result, there occurs a problem in which the data such as the telephone numbers and so on cannot be possibly restored later when the data are erroneously lost because the users don't back up or forget to back up the data. This is a big trouble on taking into consideration that the backup data are suddenly required for their utilization in many cases.

This problem similarly arises in the art in which the data are backed up in the external storage while using the connection terminals for the external information instrument which the portable telephones generally have without providing any interface in those telephones.

There has been provided an art in which the data stored in volatile memories such as RAM, SRAM and so on which are operated in association with the power supply as a charger integrated external storage rather than just the external storage are memorized in the portable telephones together with the charging operation. This is disclosed in JP5-55979.

This also has occurred such a problem that when the data to be re-memorized in the portable telephones are previously neither stored nor backed up in the external storage, the loss of the data cannot be coped with because the data stored in the peculiarly prepared external storage is just re-memorized together with the charging operation and because the data cannot be stored unless the RAM gets the state of being able to be operated by its energization and therefore the data are just re-memorized after the RAM gets the state of being able to be operated together with the charging operation or after being charged and the external storage should be provided separately from the portable telephones in preparation for consumption of the battery and brought together with the portable telephones and if otherwise, the data cannot be restored, which causes the troublesome operation to be required.

There has been proposed a charger into which an external storage such as a memory card or the like can be installed as disclosed in JU 4-110034. However, this can only keep the telephone therein and make the operation to the charger and the memory card by using a single operation and cannot prevent the loss of the data and also requires a special interface, which means that it has the same problems as the other prior arts.

There has been also proposed an art in which the data are read out and stored by a backup unit contained in a charger while the telephone is being charged, which is disclosed in JP2000-69144. In this prior art, since the data can be read out and stored only during the charging operation, in the case where the user's operation such as a switch operation for the backup of the data is separately required, it cannot cope with the loss of the data. Even though such an operation is not required, as long as the data are backed up by the instrument such as the charger managed under the user, the data cannot be restored when the failure, the destruction and the loss of the instrument happen. Thus, there arises a problem in which the user itself should be responsible for being unable to restore the data.

Since these prior arts never disclose the concrete method of connection for backing up the data between the portable telephone and the charger when this should be done during the charging operation, in the case where any peculiar interface is required between them, they cannot be applied to the existing portable telephones and in the case where the cable is required, there arises the problem of requirement of the preparation of the cable and the connection operation. Furthermore, since the portable telephones have the layout of the charging terminals and the shape different on makers or models thereof, there also arises problem in which the prior arts cannot cope with these differences.

Since any of the aforementioned prior arts has the object of only backing up the data such as the telephone numbers of the parties for telephoning the particular parties, they cannot cope with the cases where the telephone break down in such a manner as the control information required for the operation of the portable telephones such as the programs peculiar to the telephones required to get the waiting-for state of arrival and dispatch of the telephones for achieving the minimum function of the telephone is lost or damaged by any cause.

In addition thereto, in any of the prior arts, since the setup functions in which the users themselves set personal identification numbers, adjust the arrival sound of the telephones and so on cannot be backed up, the information on these setup functions other than the telephone numbers has to be reinput by the users themselves when the old telephones are replaced by the telephones newly bought, for example, which causes a problem of making the operations troublesome.

Any of the aforementioned prior arts has the object of only baking up the data stored in the portable telephone, but since various electrical appliances for household such as a refrigerator, a hot-water supply machine, an air conditioner, an audio instrument or the like have the customized setup data or control data stored therein lately, it is anticipated that the combination of the household electrical appliances and the portable telephones such as the control and the management of the household electrical appliances from the outside will be progressed by the information communication technology. In this case, although an appearance of a system which integrally manages the data of the electric appliances including the portable telephones is desired, if a peculiar instrument for the system would be prepared in view of the communication between the electrical appliances and the portable telephones for the control and the management thereof, the equipment gets large-scaled, which causes the operation to be troublesome. In order to avoid this, from the viewpoint that the portable telephones, to which an attention has been mainly paid in view of the data backup until now have also the function of the information communication instrument, it will be desirably used for it.

Although the inventor has proposed an art in which the data stored in the portable telephone are automatically backed up in association with the charging operation of the telephone (see JPA2000-100009), there is anticipated from now a development from the data management by the user itself into the data management by a contractor for the provision of the service to the user as the form of the crisis management and furthermore a development into the data management form by the contractor for specially performing the data management, but not a provider for a telephone call. A new proposal is desired for such a development of the data management by the contractor.

The object of the invention is to provide a data backup unit for a portable telephone and a method of backing up data by using the equipment adapted to be able of being applied to the existing telephones, to prevent the data from being lost without any operation of intentionally backing up the date so that the data can be used as they are and also to be easily applicable to the integral data management for the home electronics.

### DISCLOSURE OF THE INVENTION

The first feature of the invention lies in a data back up system for a portable telephone comprising a database center provided outside for backing up data such as telephone numbers and so on set and stored in the portable telephone such as a cellular phone, a personal handy phone, a car telephone, a maritime mobile radiotelephone, a satellite cellular phone machine or the like and a data backup unit including a charging section having a charging connection terminal to be connected to a charging terminal of the portable telephone to charge a battery in the portable telephone, an information transmission interface part to be connected to an external information instrument connection interface part of the portable telephone and a data control section to give a command to the portable telephone through the information transmission interface part to control the data set and stored in the portable telephone, the data control section characterized by giving the command to the portable telephone so that the data stored in the portable telephone are automatically transmitted to the database center while the portable telephone serves as a transmitter in association with a charging operation when the charging section starts to charge the battery in the portable telephone.

In this manner, as the data is transmitted to and stored in the database center by giving the command to the portable telephone when the portable telephone is charged, which has to be periodically done in the state of its normal use, the telephone numbers and so on can be positively backed up without any intentional backup operation by the users. Thus, the backing up can be done without any troublesome operation and the important data can be fully prevented from being lost due to a failure to back up the data. Since the required information is backed up in the database center, a particular instrument and a cable for backing up the data need not be prepared on the side of the user and a management of them is not required.

In this case, since the backup unit having the charging section gives the command to the portable telephone to transmit the date from the portable telephone directly to the database center, no storage medium for reading and storing the data are required in the data backup unit and therefore the construction of the data backup unit is made simpler, which causes the trouble of manufacture and the cost thereof to be reduced.

When the portable telephone is connected to the data backup unit through the external information instrument connection interface part that the existing portable telephones generally have, the command signal is transmitted to the portable telephone and therefore, any separate interface is not required for backing up the data whereby the system of the invention can be applied to the existing portable telephone. In this sense, what is meant by “the external information instrument connection interface part” of the portable telephone is not the interface part such as the connection terminal exclusively provided for applying the invention thereto, but the flexible connection terminal which the existing portable telephones generally have for being connected to the external information instrument, an infrared transceiver part (communication part) or the like.

The second feature of the invention lies in a data back up system for a portable telephone comprising a database center provided outside for backing up data such as telephone numbers and so on set and stored in the portable telephone such as a cellular phone, a personal handy phone, a car telephone, a maritime mobile radiotelephone, a satellite cellular phone machine or the like and a data backup unit to read from the portable telephone the data set and stored therein and transmit the data to the database center, the data backup unit including a charging section having a charging connection terminal to be connected to a charging terminal of the portable telephone to charge a battery in the portable telephone through the charging connection terminal, an information transmission interface part to be connected to an external information instrument connection interface part of the portable telephone, a data read section to read from the portable telephone through the information transmission interface part the data set and stored in the portable telephone and an external communication section to communicate at least with the database center, the data read section serving to automatically read from the portable telephone the data set and stored therein in association with a charging operation when the charging section starts to charge the battery in the portable telephone and the exterior communication section serving to transmit the data read by the data read section from the portable telephone to the database center.

As the data is read by the backup unit and transmitted by the exterior communication section to the database center in this manner, the data can be positively backed up without any special consciousness and in addition thereto, since the backup unit can serve as a kind of information communication instrument or information process equipment, the data can be managed in various forms and therefore the applicability can be extended. Particularly, the data can be practically used in various forms just by using the backup unit instead of the existing charger.

The third feature of the invention lies in a data backup system for a portable telephone according to the second feature wherein when it is detected that the data read section reads the data set and stored in the portable telephone, the exterior communication section automatically transmits to the database center the data set and stored in the portable telephone in association with the reading operation of the data read section.

As the data is transmitted to the database center in association with the reading operation, the data can be positively backed up because the required data is backed up without any special consciousness.

The fourth feature of the invention lies in a data backup system for a portable telephone according to the second or third feature wherein the exterior communication section transmits to the database center the data stored in the portable telephone by using as a transmitter the portable telephone connected through the information transmission interface to the data backup unit when it is to be charged.

In this manner, as the portable telephone serves as the transmitter of the data backup unit as well as the object of the data backup, the data backup unit, which is a kind of the information communication instrument, need not be provided with a separate communication means.

The fifth feature of the invention lies in a data backup system for a portable telephone according to the second or third feature wherein the exterior communication section transmits to the database center the data stored in the portable telephone by using cable or radio communication means other than the portable telephone.

As the communication other than portable telephone is used in this manner, the data can be transmitted and managed by using various communication forms or signals generally used for an information communication system such as Internet or exclusive lines and the data can be transmitted even when the portable telephone is not turned on.

The sixth feature of the invention lies in a data backup system for a portable telephone according to either of the second through fifth features wherein the data backup unit further comprises a data storage section to store the data read by the data read section and the exterior communication section automatically or at an arbitrary time transmits to the database center the data read by the data read section or the data stored by the data storage section in association with the reading operation.

In this manner, with the data stored not only in the database center, but also in the data backup unit, since the data can be stored in two places, they can be protected doubly. This causes the crisis management to be more positively performed in preparation for the loss of the data and the user to more easily manage the data. Since the stored data can be automatically transmitted at arbitrary time set by a timer and so on, the loss of the data can be positively prevented without any consciousness of the user even though the data backup unit is not connected to the database center when the portable telephone is to be charged or the data are to be read.

The seventh feature of the invention lies in a data backup system for a portable telephone according to either of the second through fifth features wherein the data backup unit further comprises a data storage section to store the data read by the data read section and the database center automatically reads and stores the data stored by the data storage section in association with the connection of the data backup unit to the database center through the exterior communication section.

In this manner, with the transmission of the data not instructed by the data backup unit, but with the data stored by the data storage section read by the database center, since the data can be stored in two places in the same manner as in the sixth feature of the invention, they can be protected doubly. This causes the crisis management to be more positively performed in preparation for the loss of the data and the user to more easily manage the data. Since the stored data can be automatically transmitted even though the data backup unit is not connected to the database center when they are connected to each other later, the data can be positively prevented from being lost without any consciousness of the user.

The eighth feature of the invention lies in a data backup system for a portable telephone according to either of the first through seventh features wherein the data backup unit or the database center comprises a feedback section to feed back the data stored in the database center to the portable telephone to re-memorize the data in the portable telephone.

As the backed up data can be fed back to the portable telephone in this manner, even if the data such as the telephone numbers or others are erroneously lost, the portable telephone can be easily restored to the original condition and therefore in the case where the old portable telephone is replaced by the new portable telephone, the data such as the telephone numbers and so on set and used in the former portable telephone can be used without any operation of re-inputting and re-setting the data.

The ninth feature of the invention lies in a data backup system for a portable telephone according to either of the first through eighth features wherein the charging connection terminals of the data backup unit and the information transmission interface part are provided in the positions corresponding to the charging terminals and the external information instrument connection terminals, respectively and removably attached onto the body of the data backup unit.

As the charging connection terminals of the data backup unit and the information transmission interface part are provided in the positions corresponding to the charging terminals and the external information instrument connection terminals, respectively in the aforementioned manner, since the data can be positively backed up just by loading the data backup unit with the portable telephone for charging it, it is not required to prepare a cable for connection of the portable telephone and the data backup unit, or to use a special interface. In addition, the system can be applied to the portable telephone of existing model only by using the data backup unit in place of the existing charger. Since only the connection parts of them to the portable telephone are made removable, the system can be simply applied to various kinds of portable telephones having various forms and arrangements by exchanging the connection parts. Furthermore, in the case where two or more portable telephones are held b y the user or the old portable telephone is replaced by the new portable telephone, the data can be appropriately backed up.

The tenth feature of the invention lies in a data backup system for a portable telephone according to either of the second through ninth features wherein the data backup unit can transmit to the database center also the data set and stored in an electrical instrument other than the portable telephone, to which the data backup unit is connected.

In this manner, as the set data or the control data customized in various domestic electrical instruments such as a refrigerator, a television set, a hot water supplier, an air conditioner, an audio instrument and so on as well as the portable telephone can be backed up, the electrical instruments including the portable telephone can be more easily managed in an integral manner. In other words, the data backup system of the invention not only serves to back up the data in the portable telephone, but also serves as an integration information management instrument and therefore it will be able to be easily applied to the home electronics, which will be expected to make a development in future.

The eleventh feature of the invention lies in a data backup system for a portable telephone according to either of the first through tenth features wherein the data, which are to be backed up and are set and stored in the portable telephone include at least a control information or a setup function information required for the operation of the portable telephone and a telephone call information such as a telephone number information, an arrival telephone number information, a dispatch telephone number information, a telephone call time or other arbitrary data.

In this manner, as the control information required for the operation of the portable telephone such as the program or the like peculiar to the portable telephone for requiring the telephone to get the waiting-for state of the arrival or the dispatch as well as the information such as the telephone numbers input by the user are backed up, even if an obstacle to the control information happens by any cause and the portable telephone breaks down, the control information can be easily restored by the backed up data.

Similarly, as various setup function information set by the user to set as the predetermined environment a waiting-for state such as an selection of a personal identification number and an arrival sound, an adjustment of an arrival sound volume and a telephone call sound volume, a setup of an answering function or a dial key lock, for example is backed up, even though these data are lost or even though an old telephone is replaced by a new telephone, the backed up data can be used for the new telephone without any trouble operation of the user's re-setting a management information.

In other words, in the invention, what is meant by “control information required for the operation of the portable telephone” is the program peculiar to the telephone and required for getting the waiting-for state of the arrival or the dispatch of the telephone, which is required for the minimum function of the telephone and what is meant by “setup function information” is the setup information such as the selection of the personal identification number and the arrival sound, the adjustment of the arrival sound volume and the telephone call sound volume, the setup of the answering function, the dial key lock and so on, which relate to various functions set by the user for setting the waiting-for state as predetermined environment.

As the arrival telephone numbers (arrival history) and the dispatch telephone numbers (dispatch history) among the telephone call information in addition to the control information, the setup function information and the telephone numbers are also backed up, even though the old data are eliminated because of the telephone call information amount exceeding the memory limit of the portable telephone, the user can have access to and use the eliminated data later. Similarly, even though the information fails to be stored in the memory dial (telephone directory), the user can have access to and use the information later. Also, as the telephone call time is backed up, it can be used for referring to the use time and the use charge later.

The twelfth feature of the invention lies in a data backup system for a portable telephone according to either of the first through eleventh features wherein the data backup unit further includes a data transmission limit section to be able to set a limit of transmission of the read and stored data to the database center whereby the data are transmitted and read unless the transmission of the data is limited by the data transmission limit section.

In this manner, as the transmission of the data to the database center can be limited, the personal data can be prevented from flowing into the exterior while the user does not know when the user dose not wish the backup of the data and the update of the data that is not to be updated can be prevented, which can bring a sense of security to the user.

The thirteenth feature of the invention lies in a data backup system for a portable telephone according to either of the first through twelfth features wherein the data backup unit or the database center further comprises a data selection section to arbitrarily select and set any of the data to be transmitted to the database center or to be read from the backup unit or the date to be fed back from the database center.

In this manner, as the data to be backed up or fed back can be selected and set, the data that the user doesn't want to update can be set up arbitrarily. Thus, the unintentional update of the data can be prevented and the unnecessary data communications can be omitted. The data that the user doesn't wish to flow into the exterior can be positively protected, which can bring a sense of security to the user.

The invention also provides some methods of backing up data for a portable telephone while using the data backup system according to the aforementioned first through thirteenth features of the invention, which will be described hereinafter.

The fourteenth feature of the invention lies in a method of backing up data set and stored in a portable telephone such as a cellular phone, a personal handy phone, a car telephone, a maritime mobile radiotelephone machine, a satellite cellular phone machine or the like, the method comprising the step of giving a command to the portable telephone so that the data set and stored in the portable telephone are automatically transmitted to a database center by the portable telephone serving as a transmitter in association with a charging operation of the portable telephone which is carried out by a data backup unit including a charging section to charge a battery in the portable telephone whereby the data set and stored in the portable telephone are stored in the database center for backing up them.

The fifteenth feature of the invention lies in a method of backing up data set and stored in a portable telephone such as a cellular phone, a personal handy phone, a car telephone, a maritime mobile radiotelephone machine, a satellite cellular phone machine or the like, the method comprising the step of automatically reading the data set and stored in the portable telephone and transmitting the read data to a database center by means of a data backup unit including a charging section to charge a battery in the portable telephone in association with a charging operation of the portable telephone which is carried out by the data backup unit whereby the data set and stored in the portable telephone are stored in the database center for backing up them.

The sixteenth feature of the invention lies in a data backup method for a portable telephone according to the fifteenth feature wherein the data set and stored in the portable telephone are automatically transmitted to the database center in association with a detection of the read operation which is performed by the data backup unit in association with the charging operation of the battery in the portable telephone which is carried out by the charging section of the data backup unit.

The seventeenth feature of the invention lies in a data backup method for a portable telephone according to the fifteenth or sixteenth feature wherein the data stored in the portable telephone are transmitted to the database center with the portable telephone as a transmitter connected to the data backup unit on its charging in accordance with a command from the data backup unit.

The eighteenth feature of the invention lies in a data backup method for a portable telephone according to the fifteenth or sixteenth feature wherein the data stored in the portable telephone are transmitted to the database center by cable or radio communication means other than the portable telephone and included in the data backup unit.

The nineteenth feature of the invention lies in a data backup method for a portable telephone according to either of the fifteenth through eighteenth features wherein the data read and stored from the portable telephone by the data backup unit or the data read from the portable telephone by the data backup unit are transmitted automatically or at an arbitrary time to the database center in association with the read operation.

The twentieth feature of the invention lies in a data backup method for a portable telephone according to either of the fifteenth through eighteenth features wherein the data read and stored from the portable telephone by the data backup unit are automatically read and stored by the database center in association with the connection of the data backup unit through exterior communication means to the database center.

The twenty-first feature of the invention lies in a data backup method for a portable telephone according to either of the fifteenth through twentieth features wherein the data stored in the database center are fed back to the portable telephone by the data backup unit or the database center to re-memorize the data in the portable telephone.

The twenty-second feature of the invention lies in a data backup method for a portable telephone according to either of the fifteenth through twenty-first features wherein charging connection terminals of the data backup unit and a information transmission interface part are provided in the positions corresponding to the charging terminals and the external information instrument connection terminals, respectively and removably attached onto the body of the data backup unit.

The twenty-third feature of the invention lies in a data backup method for a portable telephone according to either of the fifteenth through twenty-second features wherein the data backup unit can transmit to the database center the data set and stored in an electrical instrument other than the portable telephone, to which the data backup unit is connected as well.

The twenty-fourth feature of the invention lies in a data backup method for a portable telephone according to either of the fifteenth through twenty-third features wherein the data, which are to be backed up and set and stored in the portable telephone include at least a control information or a setup function information required for an operation of the portable telephone and a telephone call information such as a telephone number information, an arrival telephone number information, a dispatch telephone number information, a telephone call time or other arbitrary data.

The twenty-fifth feature of the invention lies in a data backup method for a portable telephone according to either of the fifteenth through twenty-fourth features wherein the data backup unit can set a limit of transmission of the read and stored data to the database center whereby the data are transmitted and read unless the transmission of the data is limited.

The twenty-sixth feature of the invention lies in a data backup system for a portable telephone according to either of the fifteenth through twenty-fifth features wherein the data backup unit or the database center arbitrarily selects and sets any of the data to be transmitted to the database center or to be read from the backup unit or the date to be fed back from the database center.

### BRIEF DESCRIPTION OF THE DRAWINGS

FIG. 1 is a schematic diagram of a data backup system for a portable telephone according to the first embodiment of the invention;

FIG. 2 is a schematic concept diagram of a data backup unit used for the first embodiment;

FIG. 3 is a schematic diagram of a data backup system for a portable telephone according to a second embodiment;

FIG. 4 is a schematic concept diagram of a data backup unit used for the second embodiment;

FIG. 5 is a schematic concept diagram of another data backup unit used for the second embodiment;

FIG. 6 is a schematic concept diagram of further data backup unit and a database center used for the second embodiment; and

FIG. 7 is a perspective view of a connection part of the data backup unit used for the invention.

### BEST MODE OF CARRYING OUT THE INVENTION

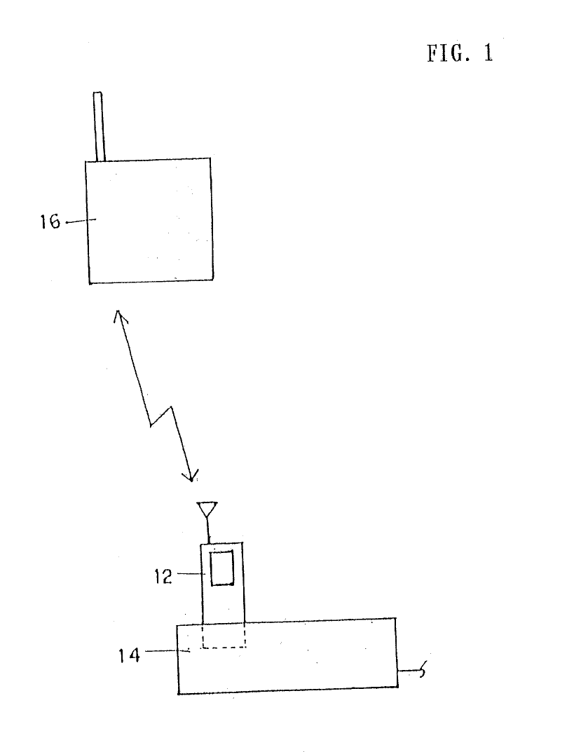

Describing some modes of embodiment for carrying out the invention, FIGS. 1 through 6 schematically illustrate a data backup system 10 for a portable telephone 12 constructed in accordance with the invention. The data backup system 10 comprises a data backup unit 14 connected to the portable telephone 12 and a database center 16 connected to the data backup unit 14 through an appropriate communication network described later.

The portable telephone 10 may be any of a cellular phone, a PHS, a car telephone, a maritime mobile radiotelephone machine, a satellite cellular phone machine and so on. Of course, it is not limited to the aforementioned ones and may include mobile communication devices having other functions as long as they have the minimum function of telephone call.

In this invention, the data such as the telephone numbers and others set and stored in the portable telephone are stored in the database center 16 provided outside thereof as shown in FIGS. 1 through 6. Thus, the user of the portable telephone is not required to peculiarly prepare and manage an equipment, a cable and so on for backing up them.

The database center 16 can be managed by an operator of the system 10 (a manager) and so on, but a contractor who offers the backup service specially may perform the operation or the management of the system or a manager of the communication network of the portable telephone 12 may provide the data backup service together with the operation or the management of a host office such as a base station of the electric wave for a telephone call or an exchange station. In any case, it is desirable to back up the data of the portable telephone after concluding an agreement with the user of the portable telephone 12 who wishes the provision of the data backup service in order to prevent the individual data of the user from flowing out without any intention.

In the invention, there are provided following two modes of embodiment for storing in the database center the data set and memorized in the portable telephone.

(First Mode of Embodiment)

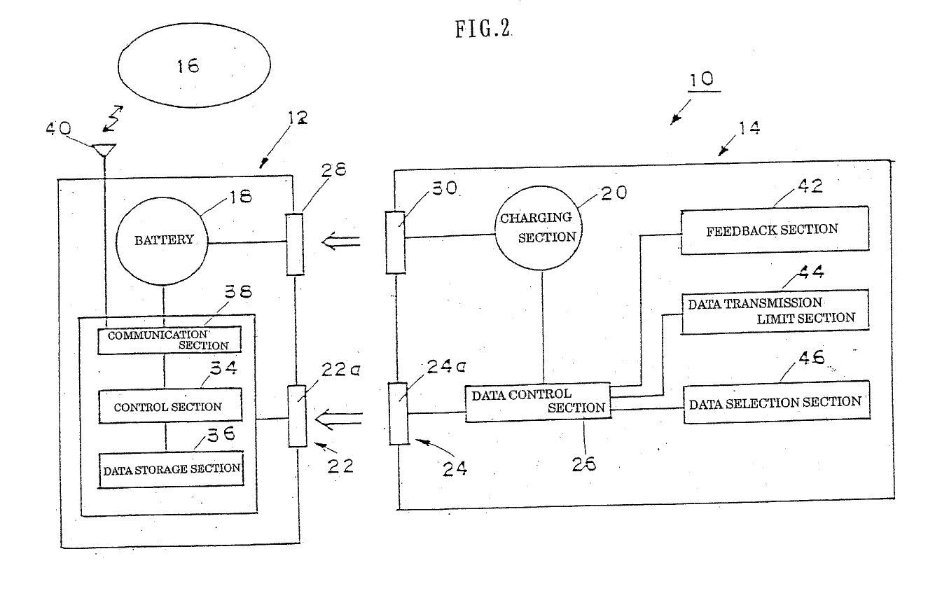

The first mode of embodiment according to the invention is shown in FIGS. 1 and 2 and may be in the form of transmitting from the portable telephone 12 directly to the database center 16 the data set and stored in the portable telephone 12.

More particularly, in the first mode of embodiment, as particularly shown in FIGS. 2, the data backup unit 14 may comprise a charging section 20 to charge a battery 18 in the portable telephone 12, an information transmission interface part 24 to be connected to an external information instrument connection interface part 22 of the portable telephone 12 and a data control section 26 to give a command through the information transmission interface part 24 to the portable telephone 12 to control the data set and stored in the portable telephone 12.

The charging section 20 has a charging connection terminal 30 to be connected to a charging terminal 28 of the portable telephone 12 and serves to charge the battery 18 in the portable telephone 12 through the charging connection terminal 30.

The information transmission interface part 24 serves to connect the portable telephone 12 with data backup unit 14 for backing up the data. In the illustrated embodiment, the external information instrument connection interface part 22 of the portable telephone 12 is shown to be an external information instrument connection terminal 22a and in correspondence to it, the information transmission interface part 24 of the data backup unit 14 may be an information transmission connection terminal 24a suitably used for the external information instrument connection terminal 22a.

In the invention, the information transmission interface part 24 of the data backup unit 14 is not a peculiar interface such as a memory slot into which a memory card is to be inserted for backing up the data, but should be set in accordance with the form of the external information instrument connection interface part 22 which the portable telephone 12 having the data to be backed up usually has for connecting it with the flexible external information instrument and therefore it is not required to add a big change to the structure of the existing portable telephone 12.

Thus, the information transmission interface part 24 may be of a standardized usual form. It will be noted from this that in the case where the target portable telephone 12 has an infrared transceiver part, for example as the external information instrument connection interface parts 22, which is different from the form of the illustrated embodiment, the information transmission interface part 24 of the data backup unit 14 may also comprise an infrared transceiver part in accordance with that of the portable telephone 12.

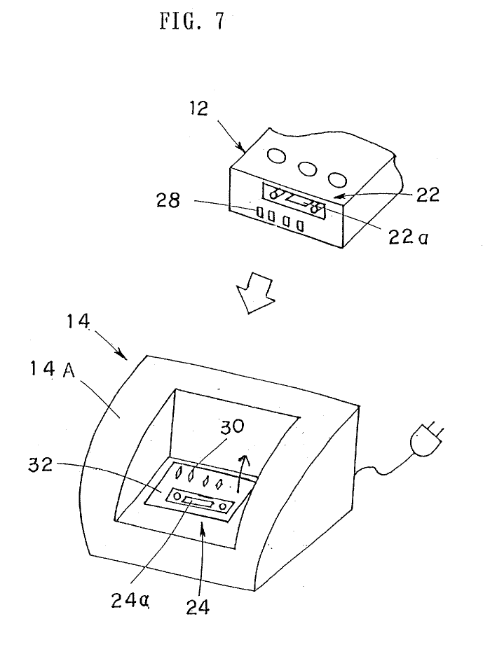

As shown in FIG. 7, the charging terminal 30 and the information transmission connection terminal 24a as the information transmission interface part 24 are arranged in the position corresponding to the charging terminal 28 of the portable telephone 12 and the external information instrument connection terminal 22a as the external information instrument connection interface parts 22 which is generally positioned close to the charging terminal 28 so that the portable telephone 12′ can be correctly put in the data backup unit 14.

Thus, the portable telephone 12 can be appropriately put in the data backup unit 14 for charging it and the data can be positively backed up just by putting the portable telephone therein. Therefore, it is not required to prepare a peculiar cable or use a peculiar interface for connecting the portable telephone 12 with the data backup unit 14 and the system can be easily applied to the existing portable telephone 12 just by using the data backup unit in place of the existing charger.

The form and arrangement of the charging terminal 28 and the external information instrument connection terminal 22a of the portable telephone 12 are not limited to those shown in FIG. 7 and may be of various types different from those. Even though they are of any type, the form and arrangement of the charging connection terminal 30 and the information transmission terminal 24a of the data backup unit 14 may be managed by being set corresponding to the charging terminal 28 and the external information instrument connection terminal 22a of the portable telephone 12.

The management of the form and arrangement of the terminals may be set every data backup unit in accordance with the used portable telephone as aforementioned, but the charging connection terminals 30 and the information transmission interface part 24 (the information transmission connection terminal 24a) are removably attached onto the body 14A of the data backup unit 14 in a desirable manner as particularly illustrated in FIG. 7. More particularly, as shown in FIG. 7, the data backup unit 14 may comprise the body 14A and a connection 32 having the terminals 30 and 24a, the latter of which may be removably attached onto the body 14A of the data backup unit 14 by suitable means such as fitting and threaded engagement.

By preparing a plural of connections 32 having the terminals 30 and 24a corresponding to every model of various portable telephones 12 having various forms and arrangements of the terminals, a producer of the data backup unit 14 can produce the body 14A of the data backup unit 14 in the same manufacture step in spite of the models while manufacturing a plural kinds of connections 32, which enables the trouble and the cost to be reduced. Accordingly, since it is sufficient if a seller provides the connections 32 corresponding to the models of the user's portable telephones, the system can be applied to a plural of existing models of the portable telephones and be easily applied to a new model of the portable telephone 12, which would be commercially sold, just by providing only the corresponding connections 32.

In the case where the user of the portable telephone 12 owns two or more than portable telephones 12 or the old portable telephone 12 is replaced by the new one, the data can be backed up while appropriately managed just by preparing or replacing only the connection or connections 32. Even though the arrangements of the terminals 30 and 24a are different from each other every connection 32, the compatibility of the connections 32 can be guaranteed by setting the connections 32 themselves and the bodies 14A so as to have the same connection state between them. The aforementioned forms of the charging connection terminals 30 and the information transmission interface part 24 of the data backup unit 14 may be applied to the second mode of embodiment described later.

As shown in FIG. 2, the data control section 26 serves to give a command to the portable telephone 12 so that the data stored in the portable telephone 12 are automatically transmitted to the database center 16 while the portable telephone 12 serves as the transmitter in association with the charging operation of the charging section 20 when it starts to charge the battery 18 in the portable telephone 12.

More particularly, as shown in FIG. 2, the data control section 26 is connected to the charging section 20 and detects the start of the charging operation of the charging section 20 to instruct the portable telephone 12 through an appropriate signal so as to transmit to the database center 16 the data to be backed up.

In this manner, by giving the command to the portable telephone 12 to transmit and store the data to the database center when the portable telephone 12 is charged, which is required to be periodically done in the ordinary state of use of the portable telephone 12, the data such as the telephone numbers and so on are positively backed up without any operation for the intentional data backup by the user, trouble can be saved and also the important data can be completely prevented from being lost due to the failure to back up the data.

In the first mode of embodiment, since the data backup unit 14 having the charging section 20 gives the command to the portable telephone 12 so as to transmit the data from the portable telephone 12 itself directly to the database center 16, the data backup unit 14 itself need not have storage medium from which the data are read or in which the data are stored, the data backup unit 14 can be easily constructed, which enables the trouble of manufacture and the cost to be reduced.

As shown in FIG. 2, the portable telephone 12 generally comprises a control section 34 to control the operation of the portable telephone 12, a data storage section 36 to store the data such as the telephone numbers and so on and a communication section 38 to deliver or receive a voice signal through radio to or from a not shown host office to perform a data communication such as telephone call with a called person and others. The data control section 26 of the data backup unit 14 gives the command to the control section 34 or the data storage section 36 of the portable telephone 12 to command it to transmit the data through the communication section 38 to the database center 16. FIG. 2 shows only the sections relating to the invention in the construction of the portable telephone 12 and a numeral 40 designates an antenna.

It is through the antenna 24 that the data are transmitted from the portable telephone 12 to the database center 16 and communication means may be a usual public circuit network, Internet etc. and the kind of the communication means is not limited thereto so long as it can positively transmit the data. Thus, the database center 16 may be provided in the form of a data communication base having the exclusive telephone number and may deliver and receive the information in the form of a Web site on Internet. The communication means may be appropriately selected as the performance of the information communication instrument for the latest portable telephone is improved.

Accordingly, a signal in the form of which the data should be backed up may be in the form of a signal such as a packet signal, TCP/IP radio signal etc., but never limited thereto and may be in the form of an appropriate other signal corresponding to the communication form. These data signal may be preferably transmitted as a signal separate from a voice signal for a telephone call in view of the data quantity and so on, but it may be transmitted while being added to the voice signal for the telephone call depending on the kind of the signal. The first mode of embodiment in which the portable telephone serves as the transmitter is similarly applied to the case where the portable telephone 12 serves as the transmitter in the second mode of embodiment.

In the invention, the data which should be transmitted to and backed up by the database center 15 may be of any kind so long as they can be read among the various data set and stored in the portable telephone 12 or may be the one which can be used as telephone directories for telephone numbers and abbreviated dialing numbers stored by the data storage section 36 of the portable telephone 12.

The data to be backed up may preferably include at least a control information required for operating the portable telephone 10 as well. More particularly, such a control information to be backed up may include a control program peculiar to the telephone and required for getting the waiting-for state of the arrival or the dispatch of the telephone, which is required for the minimum function of the telephone and stored in a non-volatility memory such as ROM, PROM and so on in the control section 34 of the portable telephone 12. With respect to the control program, it will be considered that a program such as a portable telephone operation system having a Java function in future may be installed in the portable telephone. This program may be included in the data to be backed up. In other words, the programs for controlling the portable telephone may be widely applicable to the backup in spite of the memorization method and the kind of memories to store the data. Thus, even if the telephone will be in a failure state because of the occurrence of a trouble in the control information due to any cause, the telephone can be easily restored to the original condition by feeding back the backed up data to the portable telephone 10 in a preferable manner.

In addition thereto, there may be backed up such a setup function information as the selection of the personal identification number and the arrival sound, the adjustment of the arrival sound volume and telephone call sound volume, the setup of the answering function or the dial key lock, for example, stored in the memories in the control section 34 and the data storage section 36 and set by the user for setting the waiting-for state as predetermined environment. This saves trouble not only in case that the data are eliminated, but also in case that the old portable telephone is replaced by the new portable telephone because the backed up data can be used without any operation of the user's re-setting these setup function information data.

In addition to the control information and the setup function information, there may be backed up the telephone call information such as the dispatch telephone number information, the arrival telephone number information, the telephone call time or the like and other arbitrary data stored in the volatility memory such as RAM, SRAM and so on in the data storage section 36. Especially, in the case where the telephone call information such as the arrival telephone number information (arrival history) and the dispatch telephone number information (dispatch history) are backed up, even though the old or former data happen to be eliminated because the amount of these telephone call information exceeds the limit of the memory, the user can have access to and use them later even though the user fails to write them in the dial directories. By backing up the telephone call time, it can be used for referring to the use time or use charge later. The forms of the kind of the data to be transmitted to and backed up by the database center 16 may be applicable to those of the second mode of embodiment described later.

The database center 16 to which the data are transmitted as aforementioned memorizes and stores the transmitted data in an appropriate memory medium. Any kind of medium in which the data should be stored may be used so long as the data to be backed up can be appropriately stored.

The database center 16 may judge an identification number information such as a subscriber number and so on transmitted from the portable telephone 12 together with the data transmission and can store and manage the data corresponding to the identification number in a management area corresponding to the identification number for every identification number. Thus, the data for one of the subscribers are never erroneously confused with those for the other subscribers and the data can be prevented from flowing out into the others by rejecting the transmission and reception of the data unless the identification number is coincident. The identification number is not limited to the subscriber number, but may be arbitrary one set in the portable telephone 12 for every user when it subscribes for the portable telephone 12, purchases it or applies for the services. This enables the backed up data to be used for the new portable telephone 12 when the old telephone is replaced by the new one or when the subscriber number changes.

In the illustrated embodiment, as shown in FIG. 2, the data backup unit 14 further comprises a feedback section 42 to feed back the data stored in the database center 16 to the portable telephone 12 and re-memorize the fed back data in the portable telephone 12.

In the first mode of embodiment, as shown in FIG. 2, the feedback section 42 may command the portable telephone being charged to receive the data to be fed back from the database center 16 by giving an instruction to the data backup unit 14 while applying a user's predetermined operation to the data backup unit 14 when the data are required to be fed back for any reason such as the accidental elimination of the data in the portable telephone 12 and makes the fed back data re-memorized (updated) in the various memories in the portable telephone 12 as they are or through the information transmission connection terminal 24a which is the information transmission interface part 24 after being read by the data backup unit 14 through the portable telephone 12.

This enables the data such as the telephone numbers and so on to be easily restored to the original condition even though they happen to be accidentally eliminated and in the case where the portable telephone 12 is changed by replacing the former one by the newly bought one, the data set and stored in the former portable telephone can be used as they are without inputting and re-setting them.

Since the control information is generally stored in a non-volatile memory in the portable telephone 12 and therefore it need be written when it is fed back by the feedback section 42 and re-memorized in the portable telephone 12 as aforementioned, the premise is that it may be memorized in the memory such as the non-volatile ROM of EEPROM or flash memory (flash EEPROM), the non-volatile RAM of NVRAM (RAM and EEPROM) and so on, in which the data can be electrically written or erased. Thus, the system can be applied only to the portable telephone 12 having the control information stored in such a memory as is capable of writing the information, but also to the existing portable telephone having no memory which is capable of writing the information by replacing the memory in which the control information is memorized without any big alteration.

In the first mode of embodiment and also in the second mode of embodiment described later, since the portable telephone 12 cannot be in the waiting-for state when an obstacle in the control information arises in the case where the data to be fed back through the portable telephone 12 are received, the user cannot possibly perform the process for the telephone call or the aforementioned feedback back on the side of the portable telephone 12. Thus, as shown in FIG. 1, in addition to the provision of the feedback section 42 in the portable telephone 10, in the database center 16 may be also provided a not shown center side feedback section to feed back the stored data to the portable telephone 12 and re-memorize them in the portable telephone 12 whereby a system manager informed by the user applies a feedback command to the center side feedback section or the user itself gives the feedback command to the center side feedback section through other communication means such as another telephone while the identification number is input so as to compulsorily send the data and feed back them. This enables the failure to be restored to the original condition by feeding back the control information. Of course, the other setup function information, the telephone call information and so on can be fed back to the portable telephone 12 by giving the command from the database center 16.

As shown in FIG. 2, the data backup unit 14 may further comprise a data transmission limit section 44 to set the limit of the transmission of the read and stored data to the database center 16.

This data transmission limit section 44 may generate a command signal to command the data to be prevented from the transmission to the portable telephone as the transmitter by setting the data so as not to be transmitted by a switch operation by the user if necessary. Thus, the data backup unit 14 commands the portable telephone to transmit the data to the database center 16 unless the transmission of the data is limited.

In this manner, as the transmission of the data to the database center 16 can be limited, the individual data can be prevented from flowing into the exterior while the user does not know when the user dose not wish the backup of the data and the accidental update of the data which are not required to update can be prevented. In view of backing up the data without any user's intention, the data possibly flows out while the user doesn't know. Thus, the limit of the transmission of the data can bring a sense of security to the user because it can be prevented by the intention of the user itself.

As shown in FIG. 2, the data backup unit 14 of the invention may comprise a data selection section 46 to arbitrarily select and set the data to be transmitted to the database center 16 or the data to be fed back from the database center 16 to be re-memorized.

As aforementioned, the invention can back up the various data set and stored in the portable telephone 12, but the user will not want to back up any data among the various data or to feed back and re-memorize or write any data among the backed up data. To this end, in the condition that all the data can be transmitted, the data to be transmitted to the database center 16 can be arbitrarily set so as to be able to be selected whereby the data that the user doesn't want to back up or feed back are never transmitted to the database center 16 or in the condition that all the data are backed up by the database center 16, the individual data which the user don't want to feed back by the feedback section 32 can be arbitrarily selected among all the information backed up in the database center 16. Since the transmission itself of the data is not limited by the data transmission limit section 44, but the data to be transmitted can be arbitrarily selected, the backup of the data is handled in accordance with the user's hope.

The set and selection of the data by the data selection section 46 can be arbitrarily made by the user's operating a not shown operating member provided in the data backup unit 14. Thus, the data that the user doesn't want to update can be arbitrarily set whereby the unintentional update of the data can be prevented and also the unnecessary transmission of the data can be omitted. Furthermore, since the information that the user doesn't intend to flow out can be positively protected, the sense of security can be brought to the user.

Unlike the form of the embodiment, a data selection section corresponding to the data selection section 46 may be provided also on the side of the database center 16 and the administrator of the system 10 can set and select the data in accordance with the individual report from the user.

The data transmission limit section 44 and the data selection section 46 may be provided also in the second mode of embodiment described later. The database center 16 can process and feed back the backed up information to the portable telephone 12. For instance, in the case where the control program is revised (the predetermined condition 1), a new function is easily added to the portable telephone 12 by upgrading the control signal such as the control program and then feeding it back to the portable telephone 12 to re-memorize it therein.

Furthermore, since the stored telephone numbers of the cellular phones and the PHSs which are expressed by 10 figures and stored therein (the predetermined condition 2) can be converted into the proper numbers of 11 figures and the data which are stored in Kana characters (the predetermined condition 3) can be converted into the ones in Chinese characters corresponding thereto, the existing portable telephones can be easily made to upgrade by affording the same function as the newest model to the existing telephones of the old model and the manager of the system 10 can provide an additional service to the user. The predetermined conditions can be manually, electrically or mechanically set and input in accordance with the nature thereof.

(The Second Mode of Embodiment)

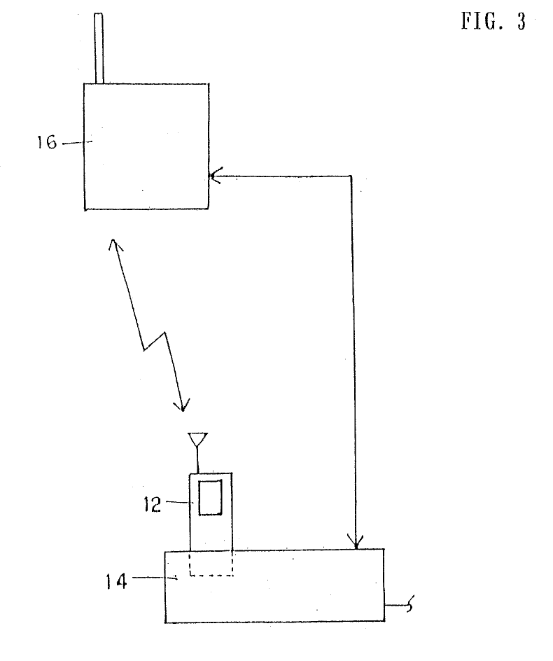

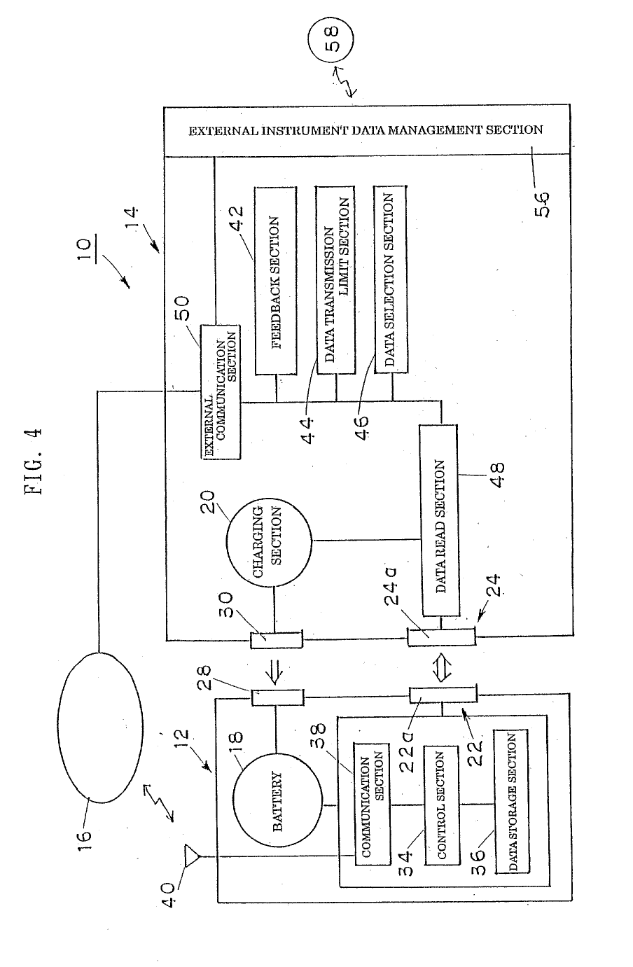

The second mode of embodiment in accordance with the invention is shown in FIGS. 3 through 6. As shown in FIG. 3, the second mode of embodiment is the one in which the data set and stored in the portable telephone 12 are read from the portable telephone to the data backup unit 14 and then transmitted to the database center 16 from the data backup unit 14. This second mode of embodiment is further divided into the following three modes shown in FIGS. 4 through 6, respectively in accordance with the transmission form of the data to the database center 16.

(2-1)

In the form of the embodiment shown in FIG. 4, the data backup unit 14 comprises the charging section 20 to charge the battery 18 in the portable telephone 12, the information transmission interface part 24 to be connected to the external information connection interface part 22 of the portable telephone 12, a data read section 48 to read the data set and stored in the portable telephone 12 through the information transmission interface part 24 and an external communication section 50 which can communicate at least with the database center 16.

As the data backup unit 14 reads the data and then transmits them through the external communication section 50 to the database center 16 as aforementioned, the data can be positively backed up without any consciousness of the user and in addition thereto, the data backup unit 14 performs a role of an information communication instrument and an information processing instrument as well. Thus, the system can manage the data in various forms and expands the applicability as described later. Especially, the data backup unit 14 can performs various practical use of the data just in place of the existing charger.

As shown in FIG. 4, the data read section 48 reads the data from the control section 34 and the data storage section 36 in which the data to be read are stored through the information transmission connection terminal 24a. In this case, the data read section 48 automatically reads the data set and stored in the portable telephone 12 in association with the charging operation of the charging section 20 to the battery in the portable telephone 12 when it starts.

More particularly, as shown in FIG. 4, the data read section 48 is connected to the charging section 20 and detects the start of the charging operation of the charging section 20 to the portable telephone 12 to read and store the data through the information transmission connection terminal 24a from the control section 34 and the data storage section 36 in which the data to be read are stored.

In other words, as the user of the portable telephone 12 puts the telephone in the data backup unit 14 as shown in FIG. 7 for charging it or being conscious of only charging it, the data can be read together with the charging operation without any special consciousness of the user.

The external communication section 50 transmits to the database center 16 the data read by the data read section 48 from the portable telephone 12. This enables the data to be backed up in the database center 16.

The external communication section 50 may be in various forms. Particularly, it may transmit the data stored in the portable telephone 12 to the database center 16 while the portable telephone 12 connected through the information transmission interface part 24 when the charging operation is made serves as the transmitter as shown in FIGS. 3 ands 4 in the same manner as in the first mode of embodiment. In this manner, as the portable telephone 12 is not only used for the object of the back up, but also given the role of the transmitter for the external communication section 50 of the data backup unit 14, no separate communication means need be prepared in the data backup unit 14 serving also as the information communication instrument.

The external communication section 50 may transmit to the database center 16 the data stored in the portable telephone 12 through cable or radio communication means other than the portable telephone 12. Particularly, the external communication section 50 may be in the transmission state with the database center 16 through a usual public circuit network using a communication modem, for example. Of course, the communication means is not limited to the communication modem and may be in the appropriate other forms used for the general information communication instrument. This causes the data backup unit 14 in the second mode of embodiment to have the function of one kind of the information communication instrument. Thus, the communication with the database center may be performed by an appropriate method such as Internet, exclusive line etc.

In this manner, as the communication means other than the portable telephone 12 is used as the external communication means, the data can be transmitted and managed by using various communication forms and signals such as the Internet, the exclusive line etc. which are generally used for an information communication instrument and especially the data can be transmitted and received even though the portable telephone 12 is not turned on. In other words, even in the first and second modes of the embodiment, the data can be transmitted through the communication modem when the portable telephone 12 is put in the data backup unit 14 for charging it without turning it on, which is different from the case where the portable telephone is used as the transmitter. In addition thereto, the data can be properly fed back by the feedback section 42 of the data backup unit 14 even when the portable telephone 12 is turned off or breaks down.

The external communication section 50 automatically transmits to the database center the data set and stored in the portable telephone in association with the read operation by the data read section, which is detected by the external communication section 50. Thus, with the data transmitted to the database center 16 in association with the read operation of the data, the user can positively back up the necessary data without any consciousness of the user.

More particularly, as shown in FIG. 4, the external communication section 50 is connected to the data read section 48 and the data read section 48 automatically transmits the data to the external communication section 50 when it reads the data or the external communication section 50 always observes the data read section 48 or receives from the data read section 48 a report signal to report that it reads the data and goes to take the data from the data read section 48 and automatically transmits them to the database center 16.

In this case, the external communication section 50 transmits the data read by the data read section 48 as they are while they gather after the read of the data ends or sequentially when each of them reads. Otherwise, the external communication section 50 may transmits the data read by the data read section 48 to the database center 16 after the read data are momentarily stored in the volatile memory or the like. In any case, in the mode of embodiment shown in FIG. 4, since the data backup unit 14 need not store the data for backing them up, the backup unit 14 itself requires no large-scale record medium, which causes the trouble of manufacture and the cost thereof to be restrained while the construction of the backup unit 14 is simplified.

(2-2)

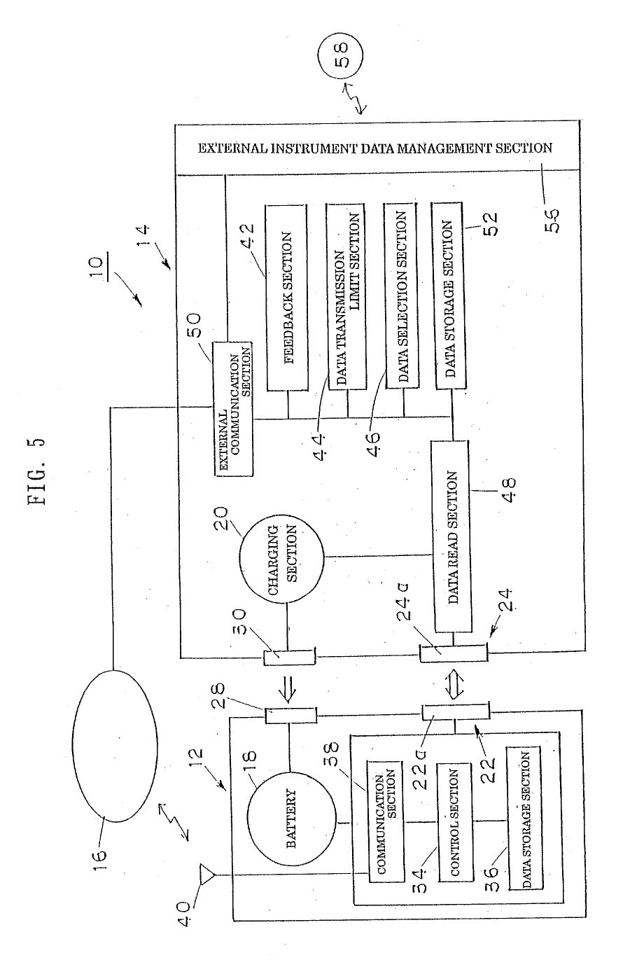

In the mode of embodiment shown in FIG. 5, the data backup unit 14 further comprises a data storage section 52 to store the data read by the data read section 48 in addition to the construction of FIG. 4. Thus, the mode of embodiment of FIG. 5 is in the form of providing the data storage means for backing up the data not only in the database center 16, but also in the data backup unit 14 itself, which is unlike the mode of embodiment shown in FIG. 4. In this manner, as the data are stored not only in the database center 16, but also in the data backup unit 14, the data can be stored in two places and therefore the data can be doubly protected. Thus, the crisis management to the loss of the data can be more substantially improved and the user can simply manage the information. The kind of medium in which the data are stored in the data storage section 52 is not limited so long as the data can be properly stored.

Although the data read by the data read section 48 can be stored in the data storage section 52 while the external communication section 50 transmits the data in association with the read operation in the same manner as in the mode of embodiment shown in FIG. 4, the data may be stored in the data storage section 52 and thereafter transmitted to the database center 16. In the latter case, the data may be once stored in the data backup unit 14 and automatically transmitted to the database center 16 in association with the reading process of the stored data or automatically transmitted thereto at an arbitrary time set by a timer or the like. This expands the method of transmission and the data can be positively transmitted later to the database center 16 for backing them up even though the data backup unit 14 is not connected to the database center 16 because of the portable telephone 12 being not turned on when it is charged (when the data are read) or cannot be connected thereto due to any obstacle. Thus, the loss of the data can be positively prevented without any consciousness of the user.

(2-3)

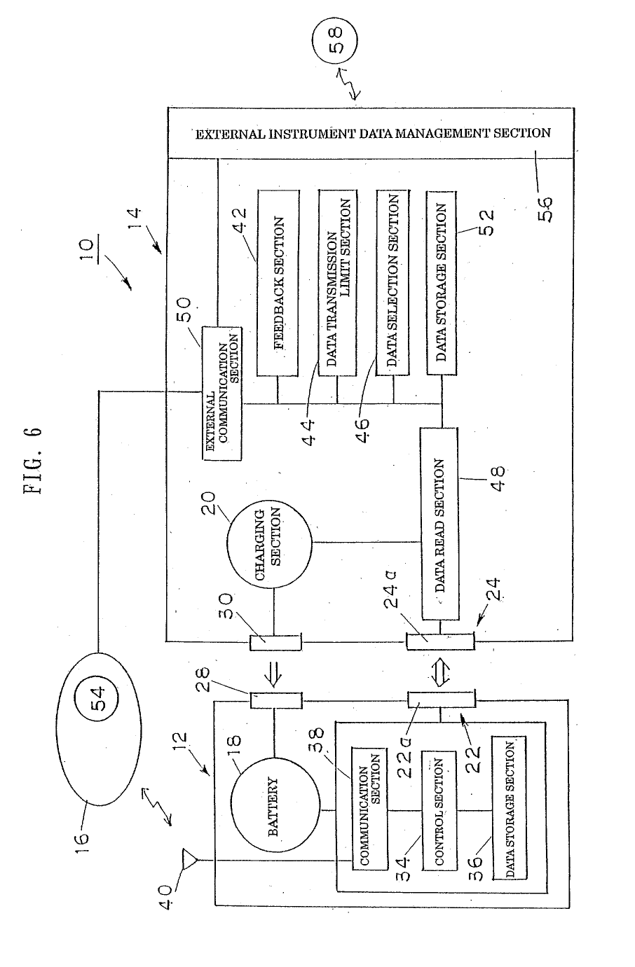

In the mode of embodiment shown in FIG. 6, the database center 16 automatically reads and stores the data stored in the data storage section 52 in association with the connection process of the data backup unit 14 to the database center 16 through the external communication section 50, which is an additional function of the mode of embodiment of FIG. 5. Although, in the modes of embodiment of FIGS. 4 and 5, the initial command for backing up the data is made in the data backup unit 14 and the data backup starts on the instruction from the backup unit 14, in the mode of embodiment of FIG. 6, the data backup starts in accordance with the instruction from the database center 16.

As shown in FIG. 6, a backup control section 54 may be provided in the database center 16, which tries to connect the database center 16 to the data backup unit 14 when the database center 16 is connected through the Internet or the like, for example or at an arbitrary time set by a timer etc., and when they are connected to each other, the database center 16 automatically reads the data from the data storage section 52 of the data backup unit 14 and back up them.

In this manner, as the data backup unit 14 does not guide the transmission of the data, but the database center 16 goes to read the data stored in the data backup unit 14, the data can be stored in two places and therefore the data can be doubly protected. Thus, the crisis management to the loss of the data can be more substantially improved and the user can simply manage the information. Even though the data backup unit 14 is not connected to the database center 16 when the telephone is charged (when the data are read), the data can be automatically read by the database center when they are connected later. Thus, the loss of the data can be positively prevented without any consciousness of the user.

In the second mode of embodiment shown in FIGS. 3 through 6, an external instrument data management section 56 may be provided especially as shown in FIGS. 4 through 6. More particularly, as shown in FIGS. 4 through 6, the external instrument management section 56 is connected to electric instruments other than the portable telephone so that it can read the data set and stored in the electric instruments 58. There may be listed various home electric instruments 58 such as a refrigerator, a television set, a hot water supplier, an air conditioner, an audio instrument and so on. The external instrument management section 56 may transmit the data to the electric instruments 58 or receive them from the electric instruments 58 through a far-infrared transceiver and so on.

As shown in FIGS. 4 through 6, the external instrument management section 56 is connected to the external communication section 50 and therefore the data set and stored in the electric instruments 58 can be transmitted to the database center 16 through the external communication section 50.

In this manner, as the set data, the control data and so on customized in various electric instruments 58 as well as the portable telephone 12 are capable of being backed up, the data of the electric instruments 58 including the portable telephone 12 can be easily managed in integration. Thus, the system 10 serves not only as the data backup system for the portable telephone 12, but also as the integral information management instrument, which will be applicable to the home electronics expected to make a development in future.

As aforementioned, the data transmission limit section 44 and the data selection section 46 may be provided in the second mode of embodiment as well, and when the data should be transmitted, the stage in which the restriction and the selection of transmission of the data are carried out can be arbitrarily set up. In the stage where the data are read by the data read section 48, for example, only the selected data may be read or the read of the data may be limited. Otherwise, in the stage where the read data are stored, the transmission of the data may be limited or selected. In the stage where the data are transmitted to the database center 16, it may be limited or selected. In this manner, the stage can be appropriately set up. This may be applied to the case where the feedback of the data by the feedback section 42 is limited or selected.

In accordance with the invention, since the data are transmitted to the database center and stored therein by giving the command to the portable telephone on the charging operation of the portable telephone, which should be periodically performed in the state of ordinary use of the portable telephone, the telephone numbers and so on can be positively backed up without any intentional backup operation by the user. Thus, the backing up can be done without any troublesome operation and the important data can be positively prevented from being lost due to a failure to back up the data. Since the necessary information is backed up in the database center, no peculiar equipment or no connection cable need be prepared or managed on the side of the user.

In this case, since the backup unit having the charging section gives the command to the portable telephone to transmit the data from the portable telephone itself directly to the database center, no storage medium from which the data are read and in which the data are stored need be provided, the construction of the backup unit gets simpler and therefore the trouble of manufacture and the cost can be reduced.

Furthermore, in accordance with the invention, since the backup unit is connected to the portable telephone through the external information instrument connection interface part that the existing portable telephone generally has and just transfers the command signal to the portable telephone, no separate interface for backing up the data need be provided and therefore the system can be easily applied to the existing portable telephone.

In the case where the data read by the backup unit are transmitted through the external communication section to the database center, the data can be positively backed up without any consciousness of the user and also since the backup unit also performs the function of a kind of information communication instrument or information processing apparatus, the data in various forms can be managed and the applicability can be expanded. Especially, the backup unit can be easily capable of practically using various data.

In accordance with the invention, since the data are transmitted to the database center in association with the read process, the necessary data can be backed up without any consciousness of the user and therefore the data can be positively backed up.

In accordance with the invention, since the portable telephone is used not only as the object of the data backup, but also serves as the transmitter for the data backup unit, it needs have no separate communication means prepared although it is also a kind of the information communication instrument.

In accordance with the invention, since the backup unit may use the communication means other than the portable telephone, the data can be transmitted and managed while using various communication forms such as Internet or exclusive line and various signals generally used for the information communication instrument. Thus, the data can be transmitted even though the portable telephone is turned off or breaks down.

In accordance with the invention, since the data are stored not only in the database center, but also in the data backup unit so that they are stored in two places, they can be doubly protected. Thus, the crisis management to the loss of the data can be improved so that the user can easily manage the information. Especially, since the data can be automatically transmitted at the arbitrary time set by the timer and so on after they are once stored, the loss of the data can be positively prevented without any consciousness of the user even though the backup unit is not connected to the database center when the portable telephone is charged (when the data are read).

In accordance with the invention, the database center may go to read the data stored in the backup unit without any guidance of the transmission of the data by the backup unit so that they are stored in two places, the data can be doubly protected and therefore the crisis management to the loss of the data can be improved so that the user can easily manage the information. Especially, since the data can be automatically read by the database center when the backup unit is connected to the database center later even though they are not connected to each other when the portable telephone is charged (when the data are read), the loss of the data can be positively prevented without any consciousness of the user.

In accordance with the invention, since the backed up data are fed back to the portable telephone, even though the data such as the telephone numbers and others are accidentally lost, they can be simply restored to the original condition. Especially, the failure of the portable telephone can be restored by feeding back the control information and also when the old portable telephone is replaced by the newly bought portable telephone, the data such as the telephone numbers and so on set and used in the old portable telephone can be used as they are, in the new portable telephone without inputting and setting them again.

In accordance with the invention, since the charging connection terminal and the information transmission interface part of the data backup unit are provided in the positions corresponding to the charging terminal and the external information instrument connection terminal of the portable telephone, the data can be positively backed up by just putting the portable telephone in the data backup unit for charging it. Thus, no cable for connecting the portable telephone to the data backup unit need be prepared or no peculiar interface need be used and the system can be applied to the portable telephone of the existing model just by using the data backup unit in place of the existing charger. Since only the connection portion of the backup unit to the portable telephone is removable relative to the data backup unit, the system can be applied to various portable telephones having various forms and dispositions just by replacing only the connection portions by each other. Furthermore, the system can be appropriately applied to the case where the user holds two or more portable telephones or the old portable telephone is replaced by the new portable telephone.

In accordance with the invention, since the set data, the control data and so on customized not only in the portable telephone, but also in various home electric instruments such as a refrigerator, a hot water supplier, an air conditioner, an audio instrument and the like can be backed up, the data in the electric instruments including the portable telephone can be simply managed in integration. Thus, the system serves not only as the backup system for the portable telephone, but also as the integrate information management instrument and therefore can be easily applied to the home electronics, which is expected to make a development in future.

In accordance with the invention, since there is backed up the control information required for the operation of the portable telephone such as the program or the like peculiar to the portable telephone for getting the waiting-for state of the arrival or the dispatch thereof in order to have the minimum function of the telephone in addition to the information such as the telephone numbers input by the user, even if an obstacle to the control information happens by any cause and the portable telephone breaks down, the control information can be easily restored by the backed up data.

Similarly, since there is backed up various setup function information such as the selection of the personal identification number and an arrival sound, the adjustment of the arrival sound volume or telephone call volume, the setup of the answering machine and the dial key lock set by the user for setting the waiting-for state as the predetermined environment, even though these data are eliminated or even though the old telephone is replaced by the new telephone, the user itself is not required to re-input the setup function information by utilizing the backed up data, which requires no troublesome operation of the user.

Since the arrival telephone number information (arrival history) and the dispatch telephone number information (dispatch history) among the telephone call information are also backed up, even though the former data are eliminated because of the telephone call information amount exceeding the memory limit of the portable telephone, the user can have access to and use the eliminated data. Especially, even though the information fails to be stored in the memory dial (telephone directory), the user can have access to and use the information later. Also, by backing up the telephone call time, it can be used for referring to the use time and the use charge later.

In accordance with the invention, since the transmission of the data to the database center can be limited as well, the personal data can be prevented from flowing out while the user does not know when it does not want to back up the data and the data not to update can be prevented from being accidentally updated, which can bring a sense of security to the user.

In accordance with the invention, since the data to be backed up or fed back can be selected and set, the data not to update can be arbitrarily set so that an unintentional update of the data not to update can be prevented and an unnecessary transmission of the data can be omitted. In addition, since the information not to flow out can be positively protected, a sense of security can be brought to the user.

### UTILIZABILITY FOR INDUSTRIES

The invention can store the arbitrary data such as the control information, the setup function information, the telephone number information, the telephone call information and so on set and stored in the portable telephone without any consciousness when the portable telephone is charged and therefore can be advantageously applied to the data storage services for the portable telephone.

1. A data back up system for a portable telephone (12) comprising a database center (16) provided outside for backing up data such as telephone numbers and so on set and stored in said portable telephone such as a cellular phone, a personal handy phone, a car telephone, a maritime mobile radiotelephone, a satellite cellular phone machine or the like and a data backup unit (14) including a charging section (20) having a charging connection terminal to be connected to a charging terminal of said portable telephone to charge a battery (18) in said portable telephone, an information transmission interface part (24) to be connected to an external information instrument connection interface part (22) of said portable telephone and a data control section (26) to give a command to said portable telephone through said information transmission interface part to control said data set and stored in said portable telephone, said data control section characterized by giving said command to said portable telephone so that said data stored in said portable telephone are automatically transmitted to said database center while said portable telephone serves as a transmitter in association with a charging operation when said charging section starts to charge said battery in said portable telephone.

2. A data back up system for a portable telephone (12) comprising a database center (16) provided outside for backing up data such as telephone numbers and so on set and stored in said portable telephone such as a cellular phone, a personal handy phone, a car telephone, a maritime mobile radiotelephone, a satellite cellular phone machine or the like and a data backup unit (14) to read from said portable telephone said data set and stored therein and transmit said data to said database center, said data backup unit including a charging section (20) having a charging connection terminal (30) to be connected to a charging terminal (28) of said portable telephone to charge a battery (18) in said portable telephone through said charging connection terminal, an information transmission interface part (24) to be connected to an external information instrument connection interface part (22) of said portable telephone, a data read section (48) to read from said portable telephone through said information transmission interface part said data set and stored in said portable telephone and an external communication section (50) to communicate at least with said database center, said data read section serving to automatically read from said portable telephone said data set and stored therein in association with a charging operation when said charging section starts to charge said battery in said portable telephone and said external communication section serving to transmit said data read by said data read section from said portable telephone to said database center.

3. A data backup system for a portable telephone according to claim 2 wherein when it is detected that said data read section reads said data set and stored in said portable telephone, said external communication section automatically transmits to said database center said data set and stored in said portable telephone in association with the read operation of said data read section.

4. A data backup system for a portable telephone according to claim 2 or 3 wherein said external communication section transmits to said database center said data stored in said portable telephone by using as a transmitter said portable telephone connected through said information transmission interface to said data backup unit when it is to be charged.

5. A data backup system for a portable telephone according to claim 2 or 3 wherein said external communication section transmits to said database center said data stored in said portable telephone by using cable or radio communication means other than said portable telephone.

6. A data backup system for a portable telephone according to either of claims 2 through 5 wherein said data backup unit further comprises a data storage section (52) to store said data read by said data read section and said external communication section automatically or at an arbitrary time transmits to said database center said data read by said data read section or said data stored by said data storage section in association with the read operation.

7. A data backup system for a portable telephone according to either of claims 2 through 5 wherein said data backup unit further comprises a data storage section (52) to store said data read by said data read section and said database center automatically reads and stores said data stored by said data storage section in association with the connection of said data backup unit to said database center through said external communication section.

8. A data backup system for a portable telephone according to either of claims 1 through 7 wherein said data backup unit or said database center comprises a feedback section (42) to feed back said data stored in said database center to said portable telephone to re-memorize said data in said portable telephone.

9. A data backup system for a portable telephone according to either of claims 1 through 8 wherein said charging connection terminal and said information transmission interface part of said data backup unit are provided in positions corresponding to said charging terminals and said external information instrument connection terminals, respectively and removably attached onto the body of said data backup unit.

10. A data backup system for a portable telephone according to either of claims 2 through 9 wherein said data backup unit can transmit to said database center also said data set and stored in an electrical instrument (58) other than said portable telephone, to which said data backup unit is connected.

11. A data backup system for a portable telephone according to either of claims 1 through 10 wherein said data, which are to be backed up and set and stored in said portable telephone include at least a control information or a setup function information required for an operation of said portable telephone and a telephone call information such as a telephone number information, an arrival telephone number information, a dispatch telephone number information, a telephone call time or other arbitrary data.

12. A data backup system for a portable telephone according to either of claims 1 through 11 wherein said data backup unit further includes a data transmission limit section (44) to be able to set a limit of transmission of said read and stored data to said database center whereby said data are transmitted and read unless the transmission of said data is limited by said data transmission limit section.

13. A data backup system for a portable telephone according to either of claims 1 through 12 wherein said data backup unit or said database center further comprises a data selection section (46) to arbitrarily select and set any of said data to be transmitted to said database center or to be read from said backup unit or said date to be fed back from said database center.

14. A method of backing up data set and stored in a portable telephone (12) such as a cellular phone, a personal handy phone, a car telephone, a maritime mobile radiotelephone machine, a satellite cellular phone machine or the like, the method comprising the step of giving a command to said portable telephone so that said data set and stored in said portable telephone are automatically transmitted to a database center (16) while said portable telephone serves as a transmitter in association with a charging operation of said portable telephone which is carried out by a data backup unit (14) including a charging section (20) to charge a battery (18) in said portable telephone whereby said data set and stored in said portable telephone are stored in said database center for storing them.

15. A method of backing up data set and stored in a portable telephone (12) such as a cellular phone, a personal handy phone, a car telephone, a maritime mobile radiotelephone machine, a satellite cellular phone machine or the like, the method comprising the step of automatically reading said data set and stored in said portable telephone and transmitting said read data to a database center (16) by means of a data backup unit (14) including a charging section (20) to charge a battery (18) in said portable telephone in association with a charging operation of said portable telephone which is carried out by said data backup unit whereby said data set and stored in said portable telephone are stored in said database center for storing them.

16. A data backup method for a portable telephone according to claim 15 wherein said data set and stored in said portable telephone are automatically transmitted to said database center in association with a detection of the read operation which is performed by said data backup unit in association with the charging operation of said battery in said portable telephone which is carried out by said charging section of said data backup unit.

17. A data backup method for a portable telephone according to claim 15 or 16 wherein said data stored in said portable telephone are transmitted to said database center with said portable telephone as a transmitter connected to said data backup unit on its charging in accordance with a command from said data backup unit.

18. A data backup method for a portable telephone according to claim 15 or 16 wherein said data stored in said portable telephone are transmitted to said database center by cable or radio communication means other than said portable telephone and included in said data backup unit.

19. A data backup method for a portable telephone according to either of claims 15 through 18 wherein said data read from said portable telephone by the data backup unit are stored, said data read from the portable telephone or said data stored in said data backup unit are transmitted automatically or at an arbitrary time to said database center in association with the read operation.

20. A data backup method for a portable telephone according to either of claims 15 through 18 wherein said data read from said portable telephone by said data backup unit are stored, said data stored in a data storage section (52) are automatically read and stored by said database center in association with the connection of said data backup unit through an external communication means (50) to said database center.

21. A data backup method for a portable telephone according to either of claims 15 through 20 wherein said data stored in said database center are fed back to said portable telephone by said data backup unit or said database center to re-memorize said data in said portable telephone.

22. A data backup method for a portable telephone according to either of claims 14 through 21 wherein a charging connection terminal (30) and a information transmission interface part (24) of said data backup unit (14) are provided in positions corresponding to a charging terminal (28) and an external information instrument connection terminal (22a) of said portable telephone, respectively and removably attached onto the body of said data backup unit.

23. A data backup method for a portable telephone according to either of claims 15 through 22 wherein said data backup unit can transmit to said database center said data set and stored in an electrical instrument (58) other than said portable telephone, to which said data backup unit is connected as well.

24. A data backup method for a portable telephone according to either of claims 14 through 23 wherein said data, which are to be backed up and set and stored in said portable telephone include at least a control information or a setup function information required for an operation of said portable telephone and a telephone call information such as a telephone number information, an arrival telephone number information, a dispatch telephone number information, a telephone call time or other arbitrary data.

25. A data backup method for a portable telephone according to either of claims 14 through 24 wherein said data backup unit can set a limit of transmission of said read and stored data to said database center whereby said data are transmitted and read unless the transmission of said data is limited by said data transmission limit section.

26. A data backup system for a portable telephone according to either of claims 14 through 25 wherein said data backup unit or said database center arbitrarily selects and sets any of said data to be transmitted to said database center or to be read from said backup unit or said date to be fed back from said database center.
